(19) United States
(12) Patent Application Publication
(10) Pub. No.: US 2017/0244644 A1
(43) Pub. Date: Aug. 24, 2017

(54) ELECTRONIC DEVICE AND METHOD FOR PROCESSING DATA IN ELECTRONIC DEVICE

(71) Applicant: SAMSUNG ELECTRONICS CO., LTD., Suwon-si (KR)

(72) Inventors: Joo-Kwan LEE, Seongnam-si (KR); Hong KIM, Seoul (KR); Sang-Hoon KIM, Suwon-si (KR); Ki-Cheol NAM, Seoul (KR)

(21) Appl. No.: 15/437,959

(22) Filed: Feb. 21, 2017

(30) Foreign Application Priority Data
Feb. 22, 2016 (KR) 10-2016-0020676

(51) Int. Cl. H04L 12/863

(52) U.S. Cl. CPC H04L 47/50

(57) ABSTRACT

Disclosed are an electronic device and a method of processing data by an electronic device. The method may include: detecting an operation mode of an application processor; storing data received through a communication processor in the communication processor when the application processor operates in a first mode; and transmitting at least some of the stored data to the application processor when the application processor operates in a second mode.

### CROSS-REFERENCE TO RELATED APPLICATION

This application is based on and claims priority under 35 U.S.C. §119 to Korean Application Serial No. 10-2016-0020676, which was filed in the Korean Intellectual Property Office on Feb. 22, 2016, the content of which is incorporated by reference herein in its entirety.

### TECHNICAL FIELD

The present disclosure relates generally to an electronic device and a method of processing data in an electronic device.

### BACKGROUND

Recently used various electronic devices are developed to include a plurality of processors. For example, when reception of data is identified through at least one of the plurality of processors, the electronic device (for example, a smart phone or a server) may transfer the data to another processor and make a control to activate at least one function of the other processor.

Recently used various electronic devices have been developed to use various functions. The electronic device has a display unit to more effectively use various functions. For example, in a case of a recent smart phone, a touch-sensitive display unit (for example, a touch screen) located on a front surface thereof is provided.

In addition, various types of applications (for example, referred to as “Apps”) may be installed and executed in the electronic device. Various input means (for example, a touch screen, buttons, a mouse, a keyboard, a sensor or the like) may be used to execute and control the applications in the electronic device.

### SUMMARY

An electronic device may include a communication processor or an application processor. As data received through the communication processor is transferred to the application processor, the application processor may increase power consumption to perform a particular function.

According to various example embodiments of the present disclosure, an electronic device and a method of processing data by an electronic device may identify data received through a communication processor and transmit the received data to the application processor based on an operation mode of the application processor or information included in the data.

In accordance with an example aspect of the present disclosure, an electronic device is provided. The electronic device includes: an application processor; and a communication processor, wherein the communication processor is configured to detect an operation mode of the application processor, to store data received through the communication processor in the communication processor when the application processor operates in a first mode, and to transmit at least some of the stored data to the application processor when the application processor operates in a second mode.

In accordance with another example aspect of the present disclosure, a method of processing data by an electronic device is provided. The method includes: detecting an operation mode of an application processor; storing data received through a communication processor in the communication processor when the application processor operates in a first mode; and transmitting at least some of the stored data to the application processor when the application processor operates in a second mode.

According to various example embodiments of the present disclosure, an electronic device and a method of processing data by an electronic device may transmit data received from the outside to an application processor based on a preset input or information included in the data and thus prevent and/or reduce unnecessary data from being transmitted to the application processor, and the application processor may reduce power consumption required for receiving and identifying the unnecessary data.

### BRIEF DESCRIPTION OF THE DRAWINGS

The above and other aspects, features, and attendant advantages of the present disclosure will be more apparent and readily appreciated from the following detailed description, taken in conjunction with the accompanying drawings, in which like reference numerals refer to like elements, and wherein:

FIG. 1 is a block diagram illustrating an example electronic device in a network environment, according to various example embodiments of the present disclosure;

FIG. 2 is a flowchart illustrating an example of the operation in which the electronic device processes data according to various example embodiments of the present disclosure;

FIG. 3 is a flowchart illustrating an example of the operation in which the electronic device filters received data according to various example embodiments of the present disclosure;

FIG. 4 is a flowchart illustrating an example of the operation for determining data which the CP transfers to the AP according to various example embodiments of the present disclosure;

FIG. 5 is a flowchart illustrating an example of the operation in which the CP transfers stored data to the AP according to various example embodiments of the present disclosure;

FIG. 6 is a diagram illustrating an example result of power consumption according to data processing by the AP according to various example embodiments of the present disclosure;

FIG. 7 is a diagram illustrating an example result of power consumption according to data processing by the AP according to various example embodiments of the present disclosure;

FIG. 8 is a block diagram illustrating an example of a network environment, according to various example embodiments of the present disclosure;

FIG. 9 is a block diagram illustrating an example electronic device according to various example embodiments of the present disclosure; and

FIG. 10 is a block diagram illustrating an example program module according to various example embodiments of the present disclosure.

### DETAILED DESCRIPTION

Hereinafter, various example embodiments of the present disclosure will be described with reference to the accompanying drawings. However, it should be understood that there is no intent to limit the present disclosure to the particular forms disclosed herein; rather, the present disclosure should be understood to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposed between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be used interchangeably with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may refer, for example, to a dedicated processor (e.g., embedded processor) for performing the corresponding operations or a generic-purpose processor (e.g., central processing unit (CPU) or application processor (AP)) that can perform the corresponding operations by executing one or more software programs stored in a memory device.

The terms used in the present disclosure are used merely to describe specific embodiments, and are not intended to limit the present disclosure. A singular expression may include a plural expression unless they are different in a context. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even if the terms are defined herein they may not be construed to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device, or the like, but is not limited thereto. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit), or the like, but is not limited thereto.

According to various embodiments of the present disclosure, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame, or the like, but is not limited thereto.

According to various embodiments of the present disclosure, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.), or the like, but is not limited thereto.

According to various embodiments of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter), or the like, but is not limited thereto. The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

According to various example embodiments of the present disclosure, a Communication Processor packet Check Room (CPCR) may be an element (e.g., including circuitry and/or program elements) for, when a Communication Processor (CP) receives a data packet from a network, determining whether to transmit the received packet to an Application Processor (AP) according to a preset condition and storing the received data packet before transmitting the data packet to the AP.

Hereinafter, an electronic device and a method of processing data by an electronic device according to various embodiments of the present disclosure will be described with reference to the accompanying drawings. In the present disclosure, the term “user” may refer to a person using an electronic device or a device (for example, an artificial intelligence electronic device) using an electronic device.

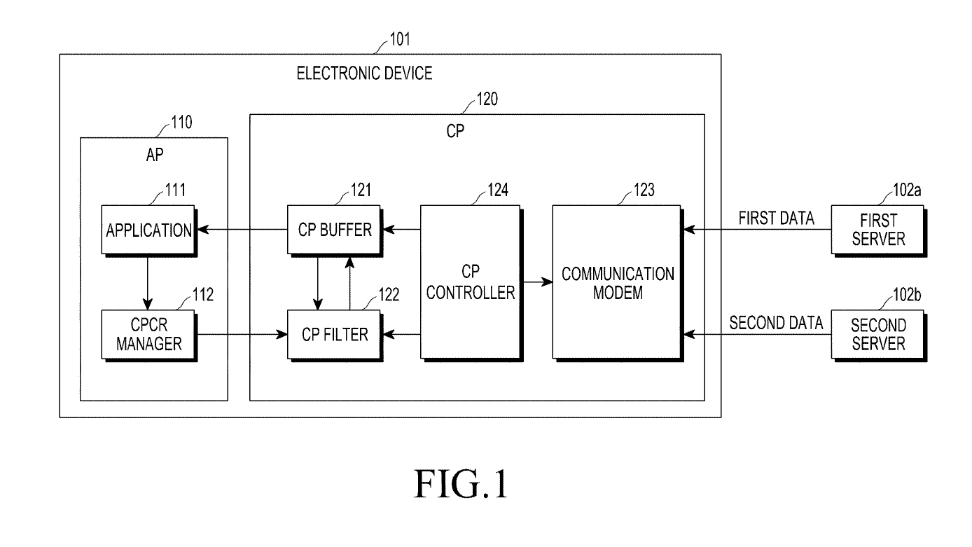

FIG. 1 is a block diagram illustrating an example electronic device in a network environment, according to various example embodiments of the present disclosure.

Referring to FIG. 1, the network environment may include an electronic device 101 or at least one server (for example, a first server 102a or a second server 102b).

The electronic device 101 may include at least one processor (for example, an AP (e.g., including processing circuitry) 110 or a CP (e.g., including processing circuitry) 120).

According to various embodiments of the present disclosure, when the CP 120 receives data from at least one server, the CP 120 may transfer the corresponding data to the AP 110 according to a type of the received data.

The AP 110 may include an application 111 and/or a CPCR manager 112.

According to various embodiments of the present disclosure, the AP 110 may operate in various operation modes according to a status of the electronic device 101 as well as the type of the transmitted data. For example, the operation modes may include an idle mode in which an operation is stopped for a predetermined time, a sleep mode in which an operation is performed with minimum power, or a wake-up mode in which a processor in the sleep mode is activated.

According to various embodiments of the present disclosure, when the AP 110 receives data from the CP 120, the AP 110 may operate in the wake-up mode, and may operate in the idle mode or the sleep mode according to a time during which the data is not received from the CP 120.

According to various embodiments of the present disclosure, the case where the AP 110 operates in the wake-up mode may include a case where an alarm set through an Operating System (OS) (for example, Android) or a particular application reaches an execution time point or its own operation is performed, a case where an element (for example, a display device or a sensor) electrically connected to the electronic device 101 is activated according to a user input (for example, clicking a button or inputting a gesture) or an interrupt (for example, detecting data), or a case where a predetermined input is received through an external device.

The application 111 may include at least one application program, and also various pieces of program information for performing the operation of the electronic device 101.

The CPCR manager 112 may identify configuration information of each of at least one application program and transfer the configuration information to the CP 120. For example, the configuration information may indicate whether a push message or a pull message for a particular application is received. For example, the push message may include a push flag bit configured therein, and the pull message may be transmitted from an external device (for example, the first server 102a or the second server 102b) through the configuration of the application 111 or the OS.

The CP 120 may include various circuitry, such as, for example, and without limitation, a CP buffer 121, a CP filter 122, a communication modem (e.g., including communication circuitry) 123, or a CP controller (e.g., including processing circuitry) 124. For example, the CP 120 may detect the reception of data from the outside, identify the received data, and determine whether to transfer the data to the AP 110.

According to various embodiments of the present disclosure, although the CP buffer 121, the CP filter 122, the communication modem 123, and the CP controller 124 are illustrated as individual elements, at least one of the elements may be changed or omitted, and one element may be configured to perform the operation of the CP buffer 121, the CP filter 122, or the CP controller 124.

The CP buffer 121 may include various circuitry/hardware configured to store data before transmission to the AP 110 among the received data. For example, the CP buffer 121 may store information such as the size of particular data, a time at which the data is received, and the number of data packets.

The CP filter 122 may include various circuitry to filter data to be transferred to the AP 110 among the received data according to a predetermined condition.

According to various embodiments of the present disclosure, the predetermined condition may be determined based on source information of the corresponding data (for example, an Internet Protocol (IP) address), destination information, data processing information, or port information. For example, the CP filter 122 may be configured to filter a particular data packet when the particular data packet is received from an unknown IP address, the particular data packet is randomly transmitted to an unclear destination, or the particular packet is received by a particular port, or configured to filter a packet which cannot be processed.

The communication modem 123 may include various communication circuitry and may be configured to transmit and receive data, and may transfer a message that informs of the reception of the data to the CP controller 124.

According to various embodiments of the present disclosure, the communication modem 123 may receive first data from the first server 102a or second data from the second server 102b. Whether the first and second data are transmitted to the AP 110 may be determined based on source/destination information included in each of the data or data processing information.

According to various embodiments of the present disclosure, when the AP 110 operates in the sleep mode, the CP 120 may control the communication modem 123 to transmit a message that informs of the operation of the electronic device 101 in the sleep mode to at least one server (for example, the first server 102a or the second server 102b). For example, following the reception of the message that informs of the operation in the sleep mode, at least one server does not transmit a paging message to the electronic device 101 and transmits the message to another server to share the operation mode of the AP 110.

The CP controller 124 may include various processing circuitry and control the general operation of the CP 120. For example, the CP controller 124 may identify the data received by the CP 120, transfer the data to the CP filter 122, make a control to filter the particular data, and determine whether to transfer the filtered data to the AP 110 or to store the filtered data in the CP buffer 121.

An electronic device (for example, the electronic device 101) according to various embodiments of the present disclosure may include: an application processor (for example, the AP 110) including various processing circuitry; and a communication processor (for example, the CP 120) including various processing circuitry, wherein the communication processor may be configured to detect an operation mode of the application processor, to store data received through the communication processor in the communication processor when the application processor operates in a first mode, and to transmit at least some of the stored data to the application processor when detecting that the application processor operates in a second mode.

The operation mode according to various embodiments of the present disclosure may include a wake-up mode in which a function of the application processor is activated, a sleep mode in which the performance of a predetermined function is stopped for a predetermined time, or an idle mode in which an operation is performed with power equal to or lower than predetermined power.

When it is detected or determined that the application processor operates in the wake-up mode, the communication processor according to various embodiments of the present disclosure may be configured to transmit the stored data to the application processor.

The communication processor according to various embodiments of the present disclosure may be configured to identify data received from an invalid sender and to delete the data received from the invalid sender, and the data received from the invalid sender may include data transmitted with no sender information or receiver information or with unidentified sender information.

The communication processor according to various embodiments of the present disclosure may be configured to transmit a message informing that the application processor operates in the sleep mode to a server (for example, a first server 102a or a second server 102b) being communicated with when it is detected that the application processor operates in the sleep mode, and the message may include data that makes a request for not transmitting a paging message through the server or data that makes a request for sharing the message to another server connected to the server.

The communication processor according to various embodiments of the present disclosure may be configured to transmit the received data to the application processor when the received data is not transmitted through a trash port or is transmitted as an emergency message.

The communication processor according to various embodiments of the present disclosure may be configured to receive, from the application processor, configuration information indicating whether at least one application receives a message, to store data received through a server of the at least one application based on the configuration information in the communication processor, and to transmit the stored data to the application processor when it is detected that the application processor operates in the second mode.

The communication processor according to various embodiments of the present disclosure may be configured to identify a first application configured to not receive a message based on the configuration information and to delete data received from a server of the first application.

The communication processor according to various embodiments of the present disclosure may be configured to receive a signal related to the operation mode from the application processor and to identify the operation mode of the application processor.

An electronic device (for example, the electronic device 101) according to various embodiments of the present disclosure may include: an application processor (for example, the AP 110); and a communication processor (for example, the CP 120) including a memory (for example, the CP buffer 121), wherein the communication processor may be configured to identify a data capacity stored in the memory and to transmit data stored in the memory to the application processor according to the data capacity.

The communication processor according to various embodiments of the present disclosure may be configured to identify data received from an invalid sender among the data stored in the memory, and to delete the data received from the invalid sender from the data stored in the memory and transmit the data to the application processor.

The communication processor according to various embodiments of the present disclosure may be configured to receive, from the application processor, configuration information indicating whether at least one application receives a message, to identify a first application configured to not receive a message based on the configuration information, and to delete data received from a server of the first application from the data stored in the memory and transmit the data to the application processor.

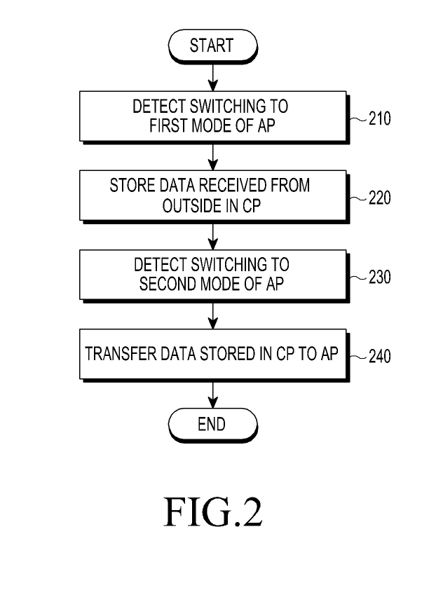

FIG. 2 is a flowchart illustrating an example of the operation in which the electronic device processes data according to various example embodiments of the present disclosure.

Referring to FIG. 2, in operation 210, the CP may detect switching of an operation mode of the AP to a first mode (for example, power saving mode). For example, the power saving mode may include a sleep mode or an idle mode, and also include various operation modes in which only an operation designated by the AP is performed or an operation requiring predetermined power or lower is performed.

In operation 220, the CP may store data received from an external electronic device in a buffer within the CP.

In operation 230, the CP may detect switching of the operation mode of the AP to a second mode (for example, non-power saving mode). For example, the non-power saving mode may include a wake-up mode.

In operation 240, the CP may transfer the data stored in the buffer to the AP.

According to various embodiments of the present disclosure, although it is illustrated that the data of the buffer of the CP is transferred to the AP according to the operation mode, the CP may also transmit the data stored in the buffer to the AP when the data stored in the buffer of the CP exceeds a predetermined capacity.

A method of processing data by an electronic device according to various embodiments of the present disclosure may include: an operation of detecting an operation mode of an application processor; an operation of storing data received through a communication processor in the communication processor when the application processor operates in a first mode; and an operation of transmitting at least some of the stored data to the application processor when it is detected that the application processor operates in a second mode.

In the method of processing the data by the electronic device according to various embodiments of the present disclosure, the operation mode may include a wake-up mode in which a function of the application processor is activated, a sleep mode in which the performance of a predetermined function is stopped for a predetermined time, or an idle mode in which an operation is performed with power equal to or lower than predetermined power.

The method of processing the data by the electronic device according to various embodiments of the present disclosure may further include an operation of transmitting the stored data to the application processor when it is detected that the application processor operates in the wake-up mode.

The method of processing the data by the electronic device according to various embodiments of the present disclosure may further include an operation of identifying data received from an invalid sender; and deleting the data received from the invalid sender, and the data received from the invalid sender may include data transmitted with no sender information or receiver information or with unidentified sender information.

The method of processing the data by the electronic device according to various embodiments of the present disclosure may further include an operation of transmitting a message informing that the application processor operates in the sleep mode to a server being communicated with when it is detected that the application processor operates in the sleep mode, wherein the message may include data that makes a request for not transmitting a paging message through the server or data that makes a request for sharing the message to another server connected to the server.

The method of processing the data by the electronic device according to various embodiments of the present disclosure may further include an operation of transmitting the received data to the application processor when the received data is not transmitted through a trash port or is transmitted as an emergency message.

The method of processing the data by the electronic device according to various embodiments of the present disclosure may further include an operation of receiving, from the application processor, configuration information indicating whether at least one application receives a message; storing data received through a server of the at least one application based on the configuration information in the communication processor; and transmitting the stored data to the application processor when it is detected that the application processor operates in the second mode.

The method of processing the data by the electronic device according to various embodiments of the present disclosure may further include an operation of identifying a first application configured to not receive a message based on the configuration information; and deleting data received from a server of the first application.

The method of processing the data by the electronic device according to various embodiments of the present disclosure may further include an operation of receiving a signal related to the operation mode from the application processor and an operation of identifying the operation mode of the application processor.

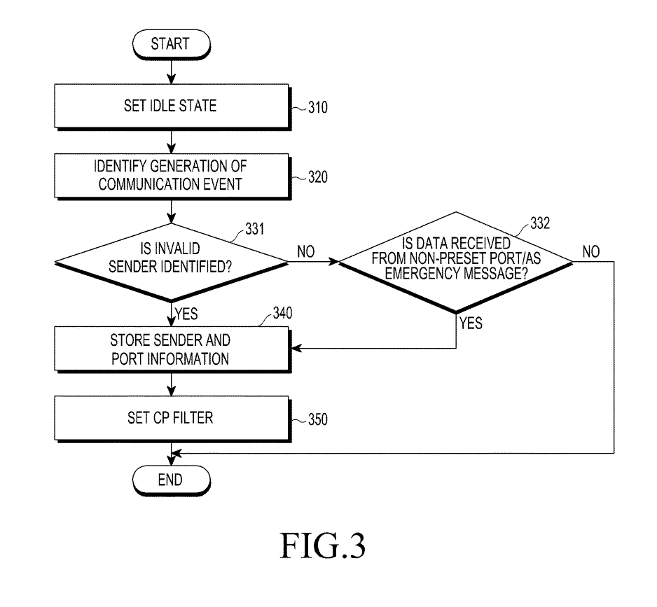

FIG. 3 is a flowchart illustrating an example of the operation in which the electronic device filters received data according to various example embodiments of the present disclosure.

Referring to FIG. 3, in operation 310, the electronic device may be configured to be in an idle state. For example, the idle state may refer to a situation in which the processor (for example, the AP) of the electronic device is controlled to enter the idle mode.

In operation 320, the electronic device may identify the generation of a communication event.

In operation 331, the electronic device may identify the received data according to the generation of the communication event and determine whether the received data is received from an invalid sender.

When it is identified that that the data is received from the invalid sender based on a result of the performance of operation 331, the electronic device may determine whether the received data is received from a non-preset port or received as an emergency message in operation 332.

When the received data is received through the non-preset port or as the emergency message from an invalid sender based on a result of the performance of operation 331 or operation 332, the electronic device may store information on the invalid sender or the non-preset port in operation 340.

In operation 350, the electronic device may configure the stored information in the CP filter to filter data including the stored information. For example, the data including the stored information may be stored in the buffer for a predetermined time or removed from the buffer through the CP filter.

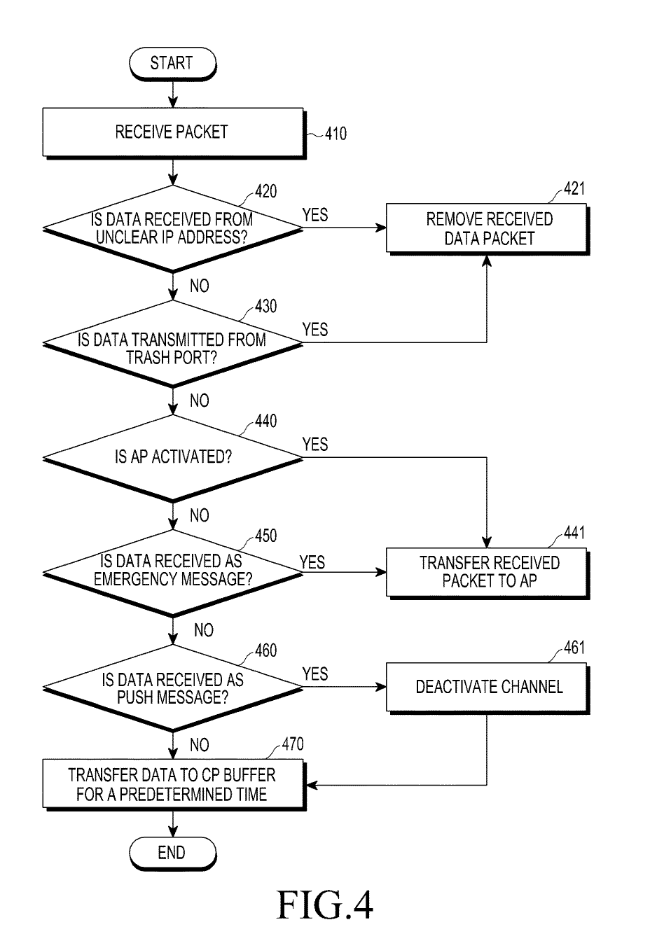

FIG. 4 is a flowchart illustrating an example of the operation for determining data which the CP transfers to the AP according to various example embodiments of the present disclosure.

Referring to FIG. 4, in operation 410, the CP may receive a data packet.

In operation 420, the CP may identify IP information of the received data and determine whether the data is received from an unclear IP address.

When the IP address is not identified based on a result of the performance of operation 420, the CP may determine whether the received data is transmitted from a trash port in operation 430. For example, the trash port may be a port of data transmitted from an invalid or unidentified sender.

According to various embodiments of the present disclosure, although it is illustrated that the CP identifies port information according to the result of the identification of the IP address, the CP may identify whether corresponding data is transmitted through the trash port by identifying the port information of the data before identifying the IP information. For example, when the CP cannot identify whether the data is transmitted through the trash port, the CP may identify a sender of the corresponding data by additionally identifying the IP information.

When the received data is received through the unclear IP address or the trash port based on a result of the performance of operation 420 and operation 430, the CP may delete the received data packet in operation 421.

When the received data is not received through the trash port based on the result of the performance of operation 430, the CP may determine whether the AP is activated in operation 440.

When the AP is not activated based on a result of the performance of operation 440, the CP may determine whether the received message is received as an emergency message in operation 450.

According to various embodiments of the present disclosure, the emergency message may be a message containing information that informs of the necessity of an immediate response or an immediate action from the sender (for example, the server) or data indicating the existence or the non-existence of a response to sleep. For example, the CP may identify an operation mode of the AP according to a value of the existence or the non-existence of the response to the sleep.

According to various embodiments of the present disclosure, the CP may determine whether the AP is activated by determining whether the CP periodically receives information related to the operation mode of the AP from the AP or a feedback signal is transmitted. For example, the CP may determine that the AP is activated in a wake-up state, and the AP is deactivated in the idle state or the sleep state.

When the AP is activated or the received data is received as the emergency message based on a result of the performance of operation 440 and operation 450, the CP may transmit the received data packet to the AP in operation 441.

When the received data is not received as the emergency message based on the result of the performance of operation 450, the CP may determine whether the received data is received as a push message in operation 460.

When the received data is received as the push message based on a result of the performance of operation 460, the CP may make a control to deactivate a channel through which the push message is received in operation 461.

According to various embodiments of the present disclosure, the CP may configure transmission of the push message from the channel to be in a fast dormancy state by transmitting a Signaling Connection Release Indication (SCRI) message. For example, in the fast dormancy state, an operation of disconnecting a connection with a particular channel may be performed directly without an operation of maintaining the connection with the corresponding channel for a predetermined period.

When the received data is not received as the push message based on the result of the performance of operation 460 or as operation 461 described above is performed, the CP may transmit the received data to the CP buffer and make a control to store the data for a predetermined time in operation 470.

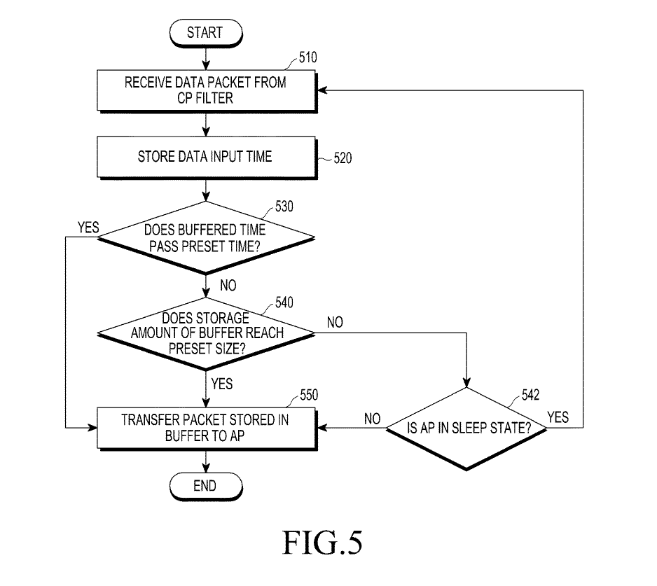

FIG. 5 is a flowchart illustrating an example of the operation in which the CP transfers stored data to the AP according to various example embodiments of the present disclosure.

Referring to FIG. 5, in operation 510, the CP may identify that a data packet is received by the buffer from the CP filter. For example, the received data may be transferred from the CP filter according to whether the received data is received from an unclear IP address or through a trash port or received as a push message.

In operation 520, the CP may store a reception time of the received data.

In operation 530, the CP may determine whether a time during which the received data is stored in the buffer reaches a preset time.

When the time during which the received data is stored does not reach the preset time based on a result of the performance of operation 530, the CP may determine whether a storage amount of the buffer reaches a preset size in operation 540.

When the storage amount of the buffer does not reach the preset size based on a result of the performance of operation 540, the CP may determine whether the AP is in the sleep state in operation 542. For example, the CP may determine that the AP is in the sleep state when the CP receives a message informing that the AP enters the sleep state from the AP or does not receive a message from the AP for a predetermined time.

When the buffered time reaches the preset time based on the result of the performance of operation 530, when the storage amount of the buffer reaches the preset size based on the result of the performance of operation 540, or when the AP is not in the sleep state based on the result of the performance of operation 542, the CP may transmit the data packet stored in the buffer to the AP in operation 550.

When the AP is in the sleep state based on the result of the performance of operation 542, the CP may perform operation 510 again and receive the data packet from the CP filter. For example, the CP may be configured to receive the data packet on a preset period or at a preset time point or to receive the data packet as a predetermined operation is performed or a predetermined state is detected.

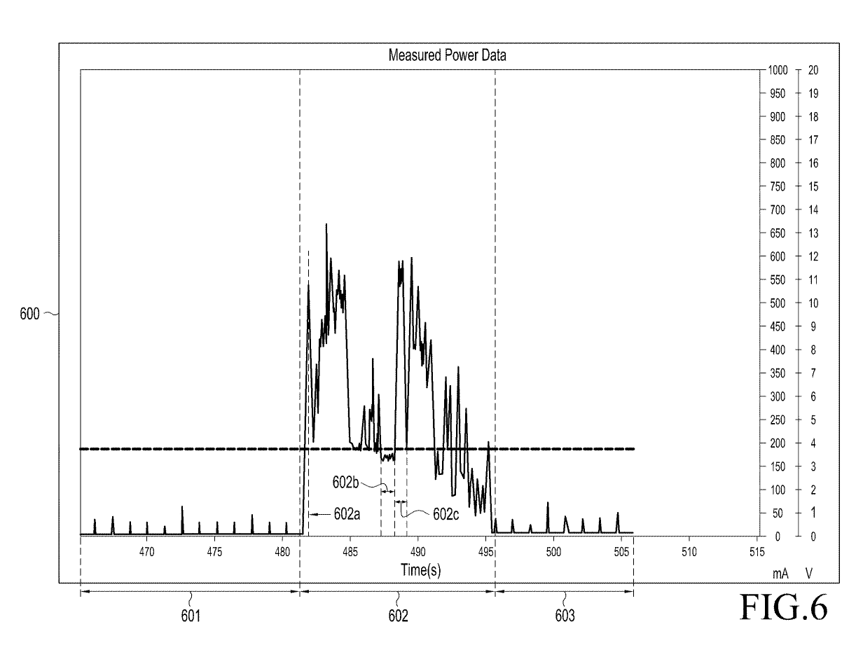

FIG. 6 is a diagram illustrating a result of power consumption according to data processing by the AP and the CP according to various example embodiments of the present disclosure.

Referring to FIG. 6, a graph 600 illustrates power consumption by the CP and the AP of the electronic device and, more specifically, measured current consumption values in a first time interval 601, a second time interval 602, and a third time interval 603.

According to various embodiments of the present disclosure, a message application of the electronic device may be configured to not receive a push message, and the AP may make a control to not output at least one message received by the application through the CP.

The CP and AP may consume power equal to or lower than a predetermined power value in the first time interval 601 and the third time interval 603, and it may be determined that the CP and AP operate in the sleep mode therein.

In the second time interval 602, a function of the AP may be activated as a particular input (for example, display activation) is made.

According to various embodiments of the present disclosure, the operation mode of the AP may switch to the wake-up mode at a first time point 602a. Thereafter, when an input is not received for a predetermined time (for example, a second time point 602b), the operation mode of the AP may switch to the idle mode. As the particular input is received again in the state where the AP has switched to the idle mode, the AP may switch back to the wake-up mode at a third time point 602c.

According to various embodiments of the present disclosure, in the first time interval 602 (for example, for 14.33 seconds), the maximum instantaneous current consumption may be measured as 700 mA and the average current consumption 702 may be measured as 1251 μAh.

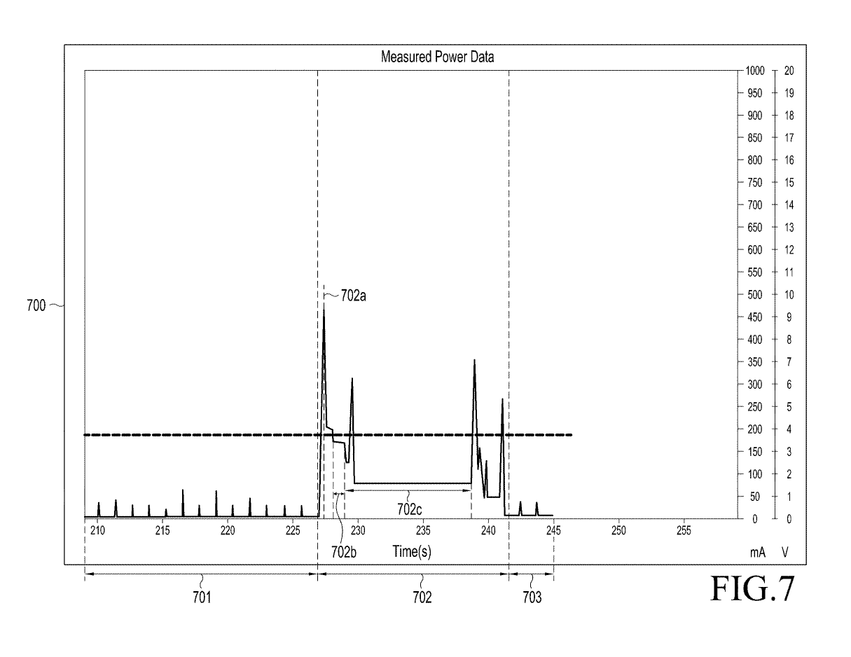

FIG. 7 is a diagram illustrating a result of power consumption according to data processing by the AP and the CP according to various example embodiments of the present disclosure.

Referring to FIG. 7, a graph 700 illustrates power consumption by the CP and the AP of the electronic device and, more specifically, measured current consumption value in a first time interval 701, a second time interval 702, and a third time interval 703.

According to various embodiments of the present disclosure, as the message application of the electronic device is configured to not receive the push message, the CP may make a control to not transmit a message related to the message application to the AP.

The CP and AP may consume power equal to or lower than a predetermined power value in the first time interval 701 and the third time interval 703, and it may be determined that the CP and AP operate in the sleep mode therein.

In the second time interval 702, a function of the AP may be activated as a particular input (for example, display activation) is made.

According to various embodiments of the present disclosure, the operation mode of the AP may switch to the wake-up mode at a first time point 702a. Thereafter, when an input is not received for a predetermined time (for example, a second time point 702b), the operation mode of the AP may switch to the idle mode.

According to various embodiments of the present disclosure, the electronic device may make a control to configure the AP and the CP to be in the fast dormancy state at a third time point 702c. For example, the electronic device may make a control to not receive the message from the server by stopping a channel connection with the server of the message application.

According to various embodiments of the present disclosure, in the second time interval 702 (for example, for 14.65 seconds), the maximum instantaneous current consumption may be measured as 500 mA and the average current consumption may be measured as 427 μAh.

According to various embodiments of the present disclosure, the electronic device may control the connection with the application server by identifying the configuration of the application and, accordingly, generate lower current consumption of the CP and the AP compared to a case where the connection with the server is not controlled.

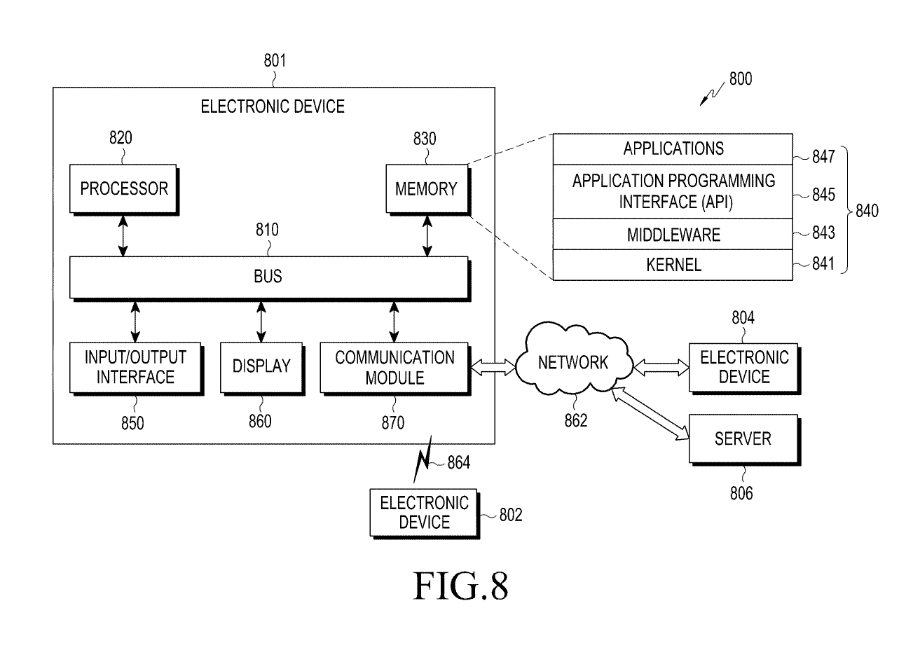

FIG. 8 is a block diagram illustrating an example of a network environment, according to various example embodiments of the present disclosure.

Referring to FIG. 8, a network environment 800 may include an electronic device 801, and at least one electronic device (for example, a first neighboring device 802 or a second neighboring device 804) or a server 806, and the elements may be connected through a network 862 or connected to the electronic device 801 through a communication module 870 of the electronic device 801.

The electronic device 801 may include a bus 810, a processor (e.g., including processing circuitry) 820, a memory 830, an input/output interface (e.g., including input/output circuitry) 850, a display 860, and a communication module (e.g., including communication circuitry) 870. In some embodiments, the electronic device 801 may omit at least one of the elements, or may further include other elements.

The bus 810 may include, for example, a circuit which interconnects the elements 810 to 870 and delivers communication (for example, a control message and/or data) between the elements 810 to 870.

The processor 820 may include various processing circuitry, such as, for example, and without limitation, one or more of a dedicated processor, a Central Processing Unit (CPU), an Application Processor (AP), and a Communication Processor (CP). The processor 820 may carry out, for example, operations or data processing relating to the control and/or communication of at least one other element of the electronic device 801.

The memory 830 may include a volatile and/or non-volatile memory. The memory 830 may store, for example, instructions or data relevant to at least one other element of the electronic device 801. According to an embodiment, the memory 830 may store software and/or a program 840. The program 840 may include, for example, a kernel 841, middleware 843, an Application Programming Interface (API) 845, and/or application programs (or “applications”) 847. At least some of the kernel 841, the middleware 843, and the API 845 may be referred to as an Operating System (OS).

For example, the kernel 841 may control or manage the system resources (for example, the bus 810, the processor 820, the memory 830, and the like) that are used to execute operations or functions implemented in the other programs (for example, the middleware 843, the API 845, and the application programs 847). Furthermore, the kernel 841 may provide an interface through which the middleware 843, the API 845, or the application programs 847 may access the individual elements of the electronic device 801 to control or manage the system resources.

The middleware 843 may function as, for example, an intermediary for allowing the API 845 or the application programs 847 to communicate with the kernel 841 to exchange data.

Furthermore, the middleware 843 may process one or more task requests, which are received from the application programs 847, according to priorities thereof. For example, the middleware 843 may assign priorities for using the system resources (for example, the bus 810, the processor 820, the memory 830, or the like) of the electronic device 801 to one or more of the application programs 847. For example, the middleware 843 may perform scheduling or loading balancing on the one or more task requests by processing the one or more task requests according to the priorities assigned to the one or more application programs.

The API 845, which is an interface through which the applications 847 control functions provided from the kernel 841 or the middleware 843, may include, for example, at least one interface or function (for example, instruction) for file control, window control, image processing, text control, or the like.

The input/output interface 850 may include various input/output circuitry and function as, for example, an interface that can forward instructions or data, which are input from a user or an external device, to the other element(s) of the electronic device 801. Furthermore, the input/output interface 850 may output instructions or data, which are received from the other element(s) of the electronic device 801, to the user or the external device.

Examples of the display 860 may include a Liquid Crystal Display (LCD), a Light-Emitting Diode (LED) display, an Organic Light-Emitting Diode (OLED) display, a MicroElectroMechanical Systems (MEMS) display, and an electronic paper display, or the like, but is not limited thereto. The display 860 may display, for example, various types of contents (for example, text, images, videos, icons, symbols, and the like) for a user. The display 860 may include a touch screen and may receive, for example, a touch, gesture, proximity, or hovering input using an electronic pen or the user's body part.

The communication module 870 may include various communication circuitry and configure communication, for example, between the electronic device 801 and an external device (for example, a first external electronic device 802, a second external electronic device 804, or a server 806). For example, the communication module 870 may be connected to a network 862 through wireless or wired communication to communicate with the external device (for example, the second external electronic device 804 or the server 806).

The wireless communication may use, for example, at least one of Long Term Evolution (LTE), LTE-Advance (LTE-A), Code Division Multiple Access (CDMA), Wideband CDMA (WCDMA), Universal Mobile Telecommunications System (UNITS), WiBro (Wireless Broadband), Global System for Mobile Communications (GSM), and the like, as a cellular communication protocol. According to an embodiment, the wireless communication may include short-range communications 864, for example, at least one of Wi-Fi, Bluetooth, Bluetooth low energy (BLE), ZigBee, near field communication (NFC), magnetic secure transmission, Radio Frequency (RF), and body area network (BAN). According to an embodiment, the wired communication may include GNSS. The GNSS may be, for example, a global positioning system (GPS), a global navigation satellite system (Glonass), a Beidou navigation satellite system (hereinafter, referred to as “Beidou”), or Galileo (the European global satellite-based navigation system). Hereinafter, in this document, the term “GPS” may be interchangeable with the term “GNSS”.

The wired communication may include, for example, at least one of a Universal Serial Bus (USB), a High Definition Multimedia Interface (HDMI), Recommended Standard 232 (RS-232), a Plain Old Telephone Service (POTS), and the like. The network 862 may include at least one of a communication network such as a computer network (for example, a LAN or a WAN), the Internet, and a telephone network.

Each of the first and second external electronic devices 802 and 804 may be of the same or a different type from the electronic device 801. According to an embodiment, the server 806 may include a group of one or more servers. According to various embodiments, all or some of the operations performed in the electronic device 801 may be performed in another electronic device or a plurality of electronic devices (for example, the electronic devices 802 and 804 or the server 806). According to an embodiment, when the electronic device 801 has to perform some functions or services automatically or in response to a request, the electronic device 801 may request another device (for example, the electronic device 802 or 804 or the server 806) to perform at least some functions relating thereto instead of, or in addition to, performing the functions or services by itself. Another electronic device (for example, the electronic device 802 or 804, or the server 806) may execute the requested functions or the additional functions, and may deliver a result of the execution to the electronic device 801. The electronic device 801 may provide the received result as it is, or may additionally process the received result to provide the requested functions or services. To this end, for example, cloud computing, distributed computing, or client-server computing technology may be used.

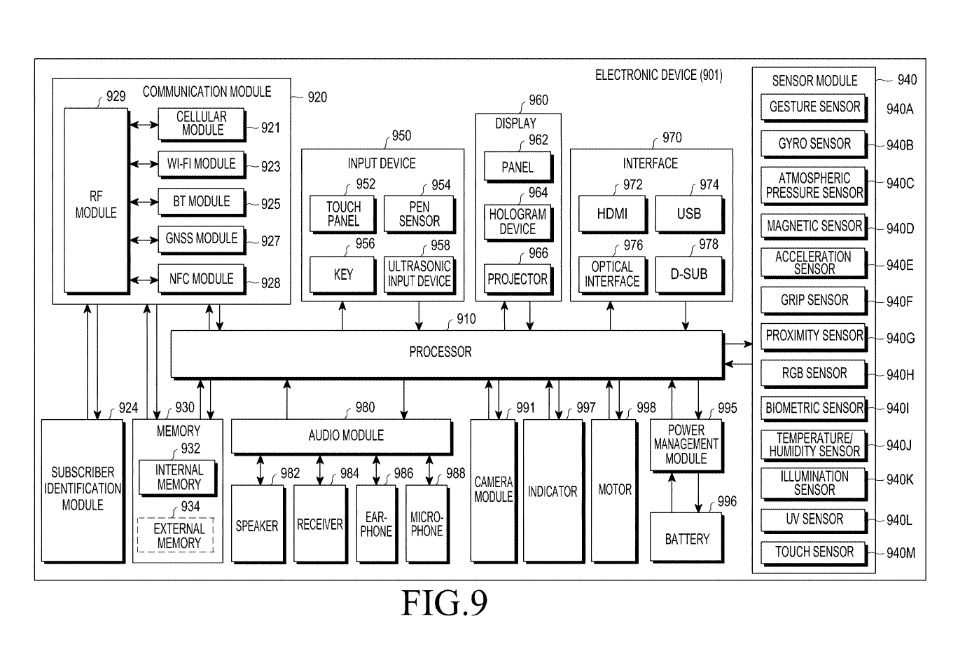

FIG. 9 is a block diagram illustrating an example configuration of an electronic device according to various example embodiments of the present disclosure.

Referring to FIG. 9, an electronic device 901 may include, for example, the entirety or a part of the electronic device 801 illustrated in FIG. 8. The electronic device 901 may include at least one Application Processor (AP) (e.g., including processing circuitry) 910, a communication module (e.g., including communication circuitry) 920, a subscriber identification module 922, a memory 930, a sensor module 940, an input device (e.g., including input circuitry) 950, a display 960, an interface 970, an audio module 980, a camera module 991, a power management module 995, a battery 996, an indicator 997, and a motor 998.

The processor 910 may include various processing circuitry and drive, for example, an operating system or application programs to control a plurality of hardware or software elements connected thereto and may perform various types of data processing and operations. The processor 910 may be embodied, for example, as a System on Chip (SoC). According to an embodiment, the processor 910 may further include a Graphic Processing Unit (GPU) and/or an image signal processor. The processor 910 may also include at least some (for example, a cellular module 921) of the elements illustrated in FIG. 9. The processor 910 may load, in a volatile memory, instructions or data received from at least one of the other elements (for example, a non-volatile memory) to process the loaded instructions or data, and may store various types of data in the non-volatile memory.

The communication module 920 may have a configuration equal or similar to that of the communication module 870 of FIG. 8. The communication module 920 may include various communication circuitry, such as, for example, and without limitation, a cellular module 921, a Wi-Fi module 923, a BT module 925, a GNSS module 927 (for example, a GPS module, a Glonass module, a Beidou module, or a Galileo module), an NFC module 928, and a Radio Frequency (RF) module 929.

The cellular module 921 may provide, for example, a voice call, a video call, a text message service, an Internet service, and the like through a communication network. According to an embodiment of the present disclosure, the cellular module 921 may identify or authenticate an electronic device 901 in the communication network by using the subscriber identification module (for example, a Subscriber Identity Module (SIM) card) 922. According to an embodiment, the cellular module 921 may perform at least some of the functions that the AP 910 may provide. According to an embodiment, the cellular module 921 may include a Communication Processor (CP).

The Wi-Fi module 923, the BT module 925, the GNSS module 927, or the NFC module 928 may include, for example, a processor for processing data that is transmitted and received through the corresponding module. In some embodiments, at least some (two or more) of the cellular module 921, the Wi-Fi module 923, the Bluetooth module 925, the GNSS module 927, and the NFC module 928 may be included in a single Integrated Chip (IC) or IC package.

The RF module 929, for example, may transmit/receive a communication signal (for example, an RF signal). The RF module 929 may include, for example, a transceiver, a Power Amplifier Module (PAM), a frequency filter, a Low Noise Amplifier (LNA), an antenna, and the like. According to another embodiment, at least one of the cellular module 921, the Wi-Fi module 923, the Bluetooth module 925, the GNSS module 927, and the NFC module 928 may transmit/receive an RF signal through a separate RF module.

The subscriber identification module 922 may include, for example, a card that includes a subscriber identity module and/or an embedded SIM, and may contain unique identification information (for example, an Integrated Circuit Card Identifier (ICCID)) or subscriber information (for example, an International Mobile Subscriber Identity (IMSI)).

The memory 930 (for example, the memory 830) may include, for example, an internal memory 932 and/or an external memory 934. The internal memory 932 may include at least one of, for example, a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (for example, a NAND flash memory or a NOR flash memory), a hard disc drive, a Solid State Drive (SSD), and the like).

The external memory 934 may further include a flash drive, for example, a Compact Flash (CF), a Secure Digital (SD), a Micro-Secure Digital (Micro-SD), a Mini-Secure Digital (Mini-SD), an extreme Digital (xD), a Multi-Media Card (MMC), a memory stick, or the like. The external memory 934 may be functionally and/or physically connected to the electronic device 901 through various interfaces.

The sensor module 940 may, for example, measure a physical quantity or detect the operating state of the electronic device 901 and may convert the measured or detected information into an electrical signal. The sensor module 940 may include, for example, at least one of a gesture sensor 940A, a gyro sensor 940B, an atmospheric pressure sensor 940C, a magnetic sensor 940D, an acceleration sensor 940E, a grip sensor 940F, a proximity sensor 940G a color sensor 940H (for example, a Red, Green, and Blue (RGB) sensor), a biometric sensor 940I, a temperature/humidity sensor 940J, an illumination sensor 940K, a ultraviolet (UV) sensor 940L, and a touch sensor 940M. Additionally or alternatively, the sensor module 940 may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 940 may further include a control circuit for controlling one or more sensors included therein. In some embodiments, the electronic device 901 may further include a processor, which is configured to control the sensor module 940, as a part of the processor 910 or separately from the processor 210 in order to control the sensor module 940 while the processor 910 is in a sleep state.

The input device 950 may include various input circuitry, such as, for example, and without limitation, a touch panel 952, a (digital) pen sensor 954, a key 956, or an ultrasonic input unit 958. The touch panel 952 may use, for example, at least one of a capacitive type, a resistive type, an infrared type, and an ultrasonic type. Furthermore, the touch panel 952 may further include a control circuit. The touch panel 952 may further include a tactile layer to provide a tactile reaction to a user.

The (digital) pen sensor 954 may include, for example, a recognition sheet that is a part of, or separate from, the touch panel. The key 956 may include, for example, a physical button, an optical key, or a keypad. The ultrasonic input device 958 may detect ultrasonic waves, which are generated by an input tool, through a microphone (for example, a microphone 988) to identify data corresponding to the detected ultrasonic waves.

The display 960 (for example, the display 860) may include a panel 962, a hologram device 964 or a projector 966. The panel 962 may have a configuration that is the same as, or similar to, that of the display 860 illustrated in FIG. 8. The panel 962 may be implemented to be, for example, flexible, transparent, or wearable. The panel 962, together with the touch panel 952, may be implemented as one module. The hologram device 964 may show a three dimensional image in the air by using an interference of light. The projector 966 may display an image by projecting light onto a screen. The screen may be located, for example, in the interior of, or on the exterior of, the electronic device 901. According to an embodiment, the display 960 may further include a control circuit for controlling the panel 962, the hologram device 964, or the projector 966.

The interface 970 may include various interface circuitry, such as, for example, and without limitation, a High-Definition Multimedia Interface (HDMI) 972, a Universal Serial Bus (USB) 974, an optical interface 976, or a D-subminiature (D-sub) 978. The interface 970 may be included in, for example, the communication interface 870 illustrated in FIG. 8. Additionally or alternatively, the interface 970 may include, for example, a Mobile High-definition Link (MHL) interface, a Secure Digital (SD) card/Multi-Media Card (MMC) interface, or an Infrared Data Association (IrDA) standard interface.

The audio module 980 may convert, for example, a sound into an electrical signal, and vice versa. At least some elements of the audio module 980 may be included, for example, in the input/output interface 845 illustrated in FIG. 8. The audio module 980 may process sound information that is input or output through, for example, a speaker 982, a receiver 984, earphones 986, the microphone 988, and the like.

The camera module 991 is, for example, a device which may photograph a still image and a video. According to an embodiment of the present disclosure, the camera module 291 may include one or more image sensors (for example, a front sensor or a back sensor), a lens, an Image Signal Processor (ISP) or a flash (for example, LED or xenon lamp).

The power management module 995 may manage, for example, the power of the electronic device 901. According to an embodiment, the power management module 995 may include a Power Management Integrated Circuit (PMIC), a charger Integrated Circuit (IC), or a battery 296 or fuel gauge. The PMIC may use a wired and/or wireless charging method. Examples of the wireless charging method may include a magnetic resonance method, a magnetic induction method, an electromagnetic wave method, and the like. Additional circuits (for example, a coil loop, a resonance circuit, a rectifier, and the like) for wireless charging may be further included. The battery gauge may measure, for example, the residual amount of the battery 996 and a voltage, current, or temperature while charging. The battery 996 may include, for example, a rechargeable battery and/or a solar battery.

The indicator 997 may indicate a particular state (for example, a booting state, a message state, a charging state, and the like) of the electronic device 901 or a part (for example, the processor 910) thereof. The motor 998 may convert an electrical signal into a mechanical vibration and may generate a vibration, a haptic effect, and the like. Although not illustrated, the electronic device 901 may include a processing unit (for example, a GPU) for supporting mobile TV. The processing unit for supporting the mobile TV may process media data according to a standard, such as Digital Multimedia Broadcasting (DMB), Digital Video Broadcasting (DVB), MediaFlo™, and the like.

Each of the above-described component elements of hardware according to the present disclosure may be configured with one or more components, and the names of the corresponding component elements may vary based on the type of electronic device.

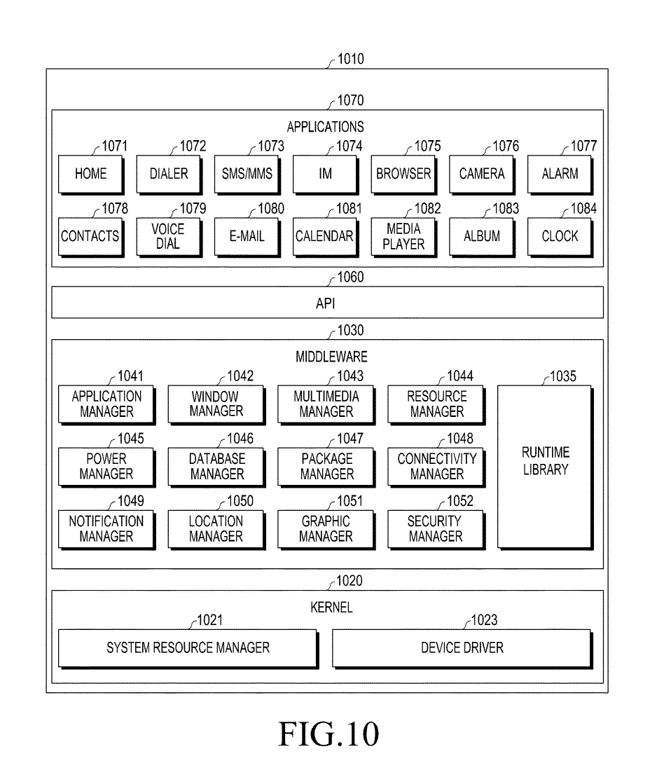

In various embodiments of the present disclosure, the electronic device may include at least one of the above-described elements. Some of the above-described elements may be omitted from the electronic device, or the electronic device may further include additional elements. Further, some of the elements of the electronic device according to various embodiments of the present disclosure may be coupled to form a single entity while performing the same functions as those of the corresponding elements before the coupling. FIG. 10 is a block diagram illustrating an example of a configuration of a program module according to various embodiments of the present disclosure.

Referring to FIG. 10, the program module 1010 (for example, the program 840) may include an Operating System (OS) for controlling resources related to the electronic device (for example, the electronic device 801) and/or various applications (for example, the application programs 847) executed in the operating system.

The operating system may be, for example, Android, iOS, Windows, Symbian, Tizen, Bada, and the like

The program module 1010 may include a kernel 1020, middleware 1030, an Application Programming Interface (API) 1060, and/or applications 1070. At least a part of the program module 1010 may be preloaded on the electronic device, or may be downloaded from an external electronic device (for example, the electronic device 802 or 804 or the server 806).

The kernel 1020 (for example, the kernel 841) may include, for example, a system resource manager 1021 and/or a device driver 1023. The system resource manager 1021 may control, allocate, or retrieve system resources. According to an embodiment, the system resource manager 1021 may include a process management unit, a memory management unit, or a file system management unit. The device driver 1023 may include, for example, a display driver, a camera driver, a Bluetooth driver, a shared memory driver, a USB driver, a keypad driver, a Wi-Fi driver, an audio driver, or an Inter-Process Communication (IPC) driver.

The middleware 1030 may provide a function required by the applications 1470 in common or provide various functions to the applications 1070 through the API 1060 so that the applications 1070 can efficiently use limited system resources within the electronic device. According to an embodiment, the middleware 1030 (for example, the middleware 843) may include, for example, at least one of a runtime library 1035, an application manager 1041, a window manager 1042, a multimedia manager 1043, a resource manager 1044, a power manager 1045, a database manager 1046, a package manager 1047, a connectivity manager 1048, a notification manager 1049, a location manager 1050, a graphic manager 1051, and a security manager 1052.

The runtime library 1035 may include, for example, a library module that a compiler uses in order to add a new function through a programming language while the applications 1070 are being executed. The runtime library 1035 may perform input/output management, memory management, the functionality for an arithmetic function, and the like.

The application manager 1041 may manage, for example, the life cycle of at least one of the applications 1070. The window manager 1042 may manage Graphical User Interface (GUI) resources used on a screen. The multimedia manager 1043 may determine formats required to reproduce various media files and may encode or decode a media file using a coder/decoder (codec) appropriate for the corresponding format. The resource manager 1044 may manage resources, such as the source code, the memory, the storage space, and the like of at least one of the applications 1070.

The power manager 1045 may operate together with, for example, a Basic Input/Output System (BIOS) to manage a battery or power and provide power information required for the operation of the electronic device. The database manager 1046 may generate, search for, and/or change a database to be used by at least one of the applications 1070. The package manager 1047 may manage the installation or update of an application that is distributed in the form of a package file.

The connectivity manager 1048 may manage a wireless connection, such as Wi-Fi, Bluetooth, and the like. The notification manager 1049 may display or notify of an event, such as an arrival message, an appointment, a proximity notification, and the like, in such a manner as not to disturb a user. The location manager 1050 may manage the location information of the electronic device. The graphic manager 1051 may manage a graphic effect to be provided to a user and a user interface relating to the graphic effect. The security manager 1052 may provide various security functions required for system security, user authentication, and the like. According to an embodiment, when the electronic device (for example, the electronic device 801) has a telephone call function, the middleware 1030 may further include a telephony manager that manages a voice or video call function of the electronic device.

The middleware 1030 may include a middleware module that forms a combination of various functions of the above-described elements. The middleware 1030 may provide specialized modules according to the types of operating systems in order to provide differentiated functions. Furthermore, the middleware 1030 may dynamically remove some of the existing elements, or may add new elements.

The API 1060 (for example, the API 845) is, for example, a set of API programming functions, and may be provided with different configurations according to operating systems. For example, in the case of Android or iOS, one API set may be provided for each platform, and in the case of Tizen, two or more API sets may be provided for each platform.

The applications 1070 (for example, the application programs 847) may include one or more applications that can perform functions, for example, home 1071, dialer 1072, SMS/MMS 1073, Instant Message (IM) 1074, browser 1075, camera 1076, alarm 1077, contacts 1078, voice dial 1079, e-mail 1080, calendar 1081, media player 1082, album 1083, clock 1084, health care (for example, measuring exercise quantity or blood sugar), and environment information (for example, atmospheric pressure, humidity, temperature information, and the like).

According to an embodiment, the applications 1070 may include an application (hereinafter, referred to as an “information exchange application” for convenience of description) that supports information exchange between the electronic device (for example, the electronic device 801) and an external electronic device (for example, the electronic device 802 or 804). The information exchange application may include, for example, a notification relay application for transferring specific information to an external electronic device or a device management application for managing an external electronic device.

For example, the notification relay application may include a function of transferring, to the external electronic device (for example, the electronic device 802 or 804), notification information that is generated from the other applications (for example, the SMS/MMS application, the e-mail application, the health care application, the environmental information application, and the like) of the electronic device. Furthermore, the notification relay application may, for example, receive notification information from the external electronic device and may provide the received notification information to a user.

The device management application may manage (for example, install, delete, or update), for example, at least one function of an external electronic device (for example, the electronic device 802 or 804) that communicates with the electronic device (for example, a function of turning on/off the external electronic device itself (or some components thereof) or a function of adjusting the brightness (or resolution) of a display), applications that operate in the external electronic device, or services (for example, a call service, a message service, and the like) that are provided by the external electronic device.

According to an embodiment, the applications 1070 may include applications (for example, a health care application of a mobile medical appliance, and the like) designated according to the attributes of an external electronic device (for example, the electronic device 802 or 804). According to an embodiment, the applications 1070 may include applications received from an external electronic device (for example, the server 806 or the electronic device 802 or 804). According to an embodiment, the applications 1070 may include a preloaded application or a third party application that may be downloaded from a server. The names of the elements of the program module 1010, according to the embodiment illustrated in the drawing, may vary according to the type of operating system.

According to various embodiments of the present disclosure, at least some of the programming module 1010 may be embodied as software, firmware, hardware, or a combination of at least two of them. At least some of the program module 1010 may be implemented (for example, executed) by, for example, the processor (for example, the processor 910). At least some of the program module 1010 may include, for example, a module, a program, a routine, a set of instructions, and/or a process for performing one or more functions.

The term “module” as used herein may, for example, refer to a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of a dedicated processor, a CPU, an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 820), may cause the one or more processors to execute the function corresponding to the instruction. The computer-readable storage medium may be, for example, the memory 830.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. Any of the hardware devices as described above may be configured to work as one or more software modules in order to perform the operations according to various embodiments of the present disclosure, and vice versa.

The programming module according to the present disclosure may include one or more of the aforementioned components or may further include other additional components, or some of the aforementioned components may be omitted.

Operations executed by a module, a programming module, or other component elements according to various embodiments of the present disclosure may be executed sequentially, in parallel, repeatedly, or in a heuristic manner. Furthermore, some operations may be executed in a different order or may be omitted, or other operations may be added.

Various example embodiments disclosed herein are provided merely to easily describe technical details of the present disclosure and to aid in understanding of the present disclosure, and are not intended to limit the scope of the present disclosure. Therefore, it should be understood that all modifications and changes or modified and changed forms based on the technical idea of the present disclosure fall within the scope of the present disclosure.

What is claimed is:

1. An electronic device comprising:
an application processor; and
a communication processor,
wherein the communication processor is configured to detect an operation mode of the application processor, to store data received through the communication processor in the communication processor when the application processor operates in a first mode, and to transmit at least some of the stored data to the application processor when the application processor operates in a second mode.

2. The electronic device of claim 1, wherein the operation mode includes one or more of a wake-up mode wherein a function of the application processor is activated, a sleep mode wherein the performance of a predetermined function is stopped for a predetermined time, or an idle mode wherein an operation is performed with power equal to or lower than predetermined power.

3. The electronic device of claim 2, wherein, when the application processor operates in the wake-up mode, the communication processor is configured to transmit the stored data to the application processor.

4. The electronic device of claim 1, wherein the communication processor is configured to identify data received from an invalid sender and to delete the data received from the invalid sender, and
wherein the data received from the invalid sender includes data transmitted with at least one of: no sender information, no receiver information or with unidentified sender information.

5. The electronic device of claim 2, wherein the communication processor is configured to transmit a message that the application processor operates in the sleep mode to a server being communicated with when the application processor operates in the sleep mode, and the message includes data that makes a request for not transmitting a paging message through the server or data that makes a request for sharing the message to another server connected to the server.

6. The electronic device of claim 1, wherein the communication processor is configured to transmit the received data to the application processor when the received data is not transmitted through a trash port and/or is transmitted as an emergency message.

7. The electronic device of claim 1, wherein the communication processor is configured to receive, from the application processor, configuration information indicating whether at least one application operates in a mode to receive a message, to store data received through a server of the at least one application based on the configuration information in the communication processor, and to transmit the stored data to the application processor when the application processor operates in the second mode.

8. The electronic device of claim 7, wherein the communication processor is configured to identify a first application configured to not receive a message based on the configuration information and to delete data received from a server for the first application.

9. The electronic device of claim 1, wherein the communication processor is configured to receive a signal related to the operation mode from the application processor and to identify the operation mode of the application processor.

10. A method of processing data by an electronic device, the method comprising:
detecting an operation mode of an application processor;
storing data received through a communication processor in the communication processor when the application processor operates in a first mode; and
transmitting at least some of the stored data to the application processor when the application processor operates in a second mode.

11. The method of claim 10, wherein the operation mode includes one or more of a wake-up mode in which a function of the application processor is activated, a sleep mode in which the performance of a predetermined function is stopped for a predetermined time, or an idle mode in which an operation is performed with power equal to or lower than predetermined power.

12. The method of claim 11, further comprising transmitting the stored data to the application processor when the application processor operates in the wake-up mode.

13. The method of claim 10, further comprising:
identifying data received from an invalid sender; and
deleting the data received from the invalid sender,
wherein the data received from the invalid sender includes data transmitted with one or more of no sender information, no receiver information or with unidentified sender information.

14. The method of claim 11, further comprising transmitting a message that the application processor operates in the sleep mode to a server being communicated with when the application processor operates in the sleep mode, wherein the message includes data that makes a request for not transmitting a paging message through the server or data that makes a request for sharing the message to another server connected to the server.

15. The method of claim 10, further comprising transmitting the received data to the application processor when the received data is not transmitted through a trash port and/or is transmitted as an emergency message.

16. The method of claim 10, further comprising:
receiving, from the application processor, configuration information indicating whether at least one application operates in a mode to receive a message;
storing data received through a server of the at least one application based on the configuration information in the communication processor;
transmitting the stored data to the application processor when the application processor operates in the second mode;
identifying a first application configured to not receive a message based on the configuration information; and
deleting data received from a server for the first application.

17. The method of claim 10, further comprising receiving a signal related to the operation mode from the application processor and identifying the operation mode of the application processor.

18. An electronic device comprising:
an application processor; and
a communication processor including a memory,
wherein the communication processor is configured to identify a data capacity of the memory and to transmit data stored in the memory to the application processor based on the data capacity.

19. The electronic device of claim 18, wherein the communication processor is configured to identify data received from an invalid sender among the data stored in the memory, and to delete the data received from the invalid sender from the data stored in the memory and to transmit the data to the application processor.

20. The electronic device of claim 18, wherein the communication processor is configured to receive, from the application processor, configuration information indicating whether at least one application operates in a mode to receive a message, to identify a first application configured to not receive a message based on the configuration information, and to delete data received from a server of the first application from the data stored in the memory and to transmit the data to the application processor.
